(19) United States
(12) Patent Application Publication
(10) Pub. No.: US 2025/0100028 A1
(43) Pub. Date: Mar. 27, 2025

(54) DRAIN CLEANER

(71) Applicant: TECHTRONIC CORDLESS GP, Anderson, SC (US)

(72) Inventors: Andrew J. Scangamor, Anderson, SC (US); Mason A. Matlock, Mauldin, SC (US); Justin Meyer, Greenville, SC (US); Nicholas S. Norton, Anderson, SC (US); Calvin A. Siegert, Greenville, SC (US); Guan Fu LIANG, Dongguan City (CN); Yi MAI, Dongguan City (CN)

(21) Appl. No.: 18/471,928

(22) Filed: Sep. 21, 2023

(51) Int. Cl. B08B 9/047

(52) U.S. Cl. CPC B08B 9/047

(57) ABSTRACT

A drain cleaner includes a housing having an interior, a cover coupled to the housing over the interior, a nose assembly extending forwardly from the cover to define a first grip, a handle assembly extending rearwardly from the housing and including a second grip, and a motor positioned within the housing. The motor defines a rotation axis. The drain cleaner also includes a drum positioned within the interior. The drum is operable to be rotated by the motor relative to the housing. The drain cleaner also includes a flexible cable stored within the drum. The flexible cable is configured to be extended out of the drum and into a drain. Last, the drain cleaner includes an auxiliary handle extending from the cover with a third grip. The auxiliary handle defines an opening between the third grip and the cover.

### FIELD OF INVENTION

The present invention relates to drain cleaners used to clean and remove debris from pipes and other conduits.

### BACKGROUND

Drain cleaners, or augers, typically include a drum containing a cable or snake. The cable is extendable out of the drum and into a conduit to be cleaned. Rotating the drum spins the cable to clean and remove debris from the conduit. Some drain cleaners are handheld and can be supported by a user. In addition, the drain cleaner may include a cover to enclose the drum and prevent a user from accessing the drum during operation of the drain cleaner.

### SUMMARY

In one embodiment, the invention provides a drain cleaner including a housing having an interior, a cover coupled to the housing over the interior, a nose assembly extending forwardly from the cover to define a first grip, a handle assembly extending rearwardly from the housing and including a second grip, and a motor positioned within the housing. The motor defines a rotation axis. The drain cleaner also includes a drum positioned within the interior. The drum is operable to be rotated by the motor relative to the housing. The drain cleaner also includes a flexible cable stored within the drum. The flexible cable is configured to be extended out of the drum and into a drain. Last, the drain cleaner includes an auxiliary handle extending from the cover with a third grip. The auxiliary handle defines an opening between the third grip and the cover.

In another embodiment, the invention provides a drain cleaner including a housing having an interior and a motor positioned within the housing. The motor defines a rotation axis. The drain cleaner also includes a drum positioned within the housing. The drum operable to be rotated by the motor relative to the housing. The drain cleaner also includes a flexible cable stored within the drum. The flexible cable configured to be extended out of the drum and into a drain. The drain cleaner also includes a cover pivotably coupled to the housing. The cover pivotable between a closed position, in which the drum is enclosed within the interior, and an open position, in which the drum is accessible.

In yet another embodiment, the invention provides a system including an organization system having a cleat and a drain cleaner. The drain cleaner includes a housing, a motor positioned within the housing, and a handle assembly extending from the housing. The handle assembly includes a stand with an opening. The opening configured to receive the cleat to connect the drain cleaner to the organization system. The drain cleaner also includes a drum positioned within the housing. The drum operable to be rotated by the motor relative to the housing. The drain cleaner further includes a flexible cable stored within the drum. The flexible cable configured to be extended out of the drum and into a drain.

Other aspects of the invention will become apparent by consideration of the detailed description and accompanying drawings.

### BRIEF DESCRIPTION OF THE DRAWINGS

FIG. 1 is a rear perspective view of a drain cleaner according to one embodiment.

FIG. 2 is a front perspective view of the drain cleaner of FIG. 1.

FIG. 2A is a partially exploded view of the drain cleaner of FIG. 1.

FIG. 3 is a cross-sectional view of the drain cleaner taken along section line 3-3 of FIG. 1.

FIG. 4 is a perspective view of the drain cleaner of FIG. 1 with a cover in an open position.

FIG. 5 is a detailed view of a portion of the drain cleaner of FIG. 1 with a first latch mechanism in a first position.

FIG. 6 is a detailed view of a portion of the drain cleaner of FIG. 1 with the first latch mechanism in a second position.

FIG. 7 is a detailed view of a portion of the drain cleaner of FIG. 1 with a second latch mechanism in a first position.

FIG. 8 is a detailed view of a portion of the drain cleaner of FIG. 1 with the second latch mechanism in a second position.

FIG. 9 is a perspective view of the drain cleaner of FIG. 1 with the cover moving to a pivoting position.

FIG. 10 is a detailed view of a portion of the cover of the drain cleaner of FIG. 1.

FIG. 11 is a detailed view of a portion of the drain cleaner of FIG. 1 with the cover removed.

FIG. 12 is a perspective view of the drain cleaner of FIG. 1 with the cover in the open position and a drum removed.

FIG. 13 is a bottom perspective view of the drain cleaner of FIG. 1.

FIG. 14 is a plan view of a system including the drain cleaner of FIG. 1 and a wall organization system.

FIG. 15 is a bottom perspective view of a drain cleaner according to another embodiment.

FIG. 16 is a plan view of a system including the drain cleaner of FIG. 15 and a wall organization system.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

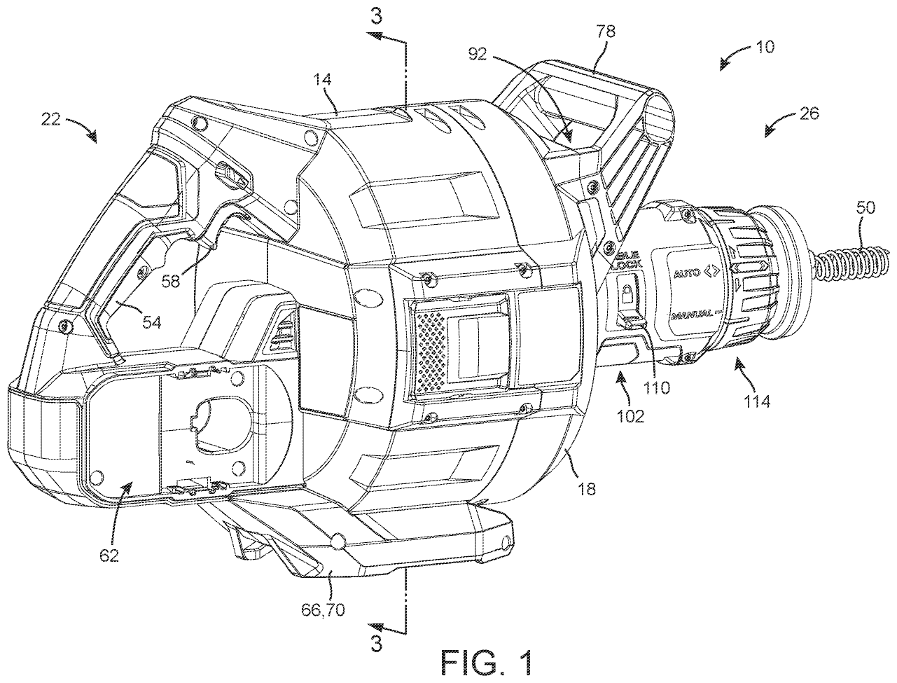

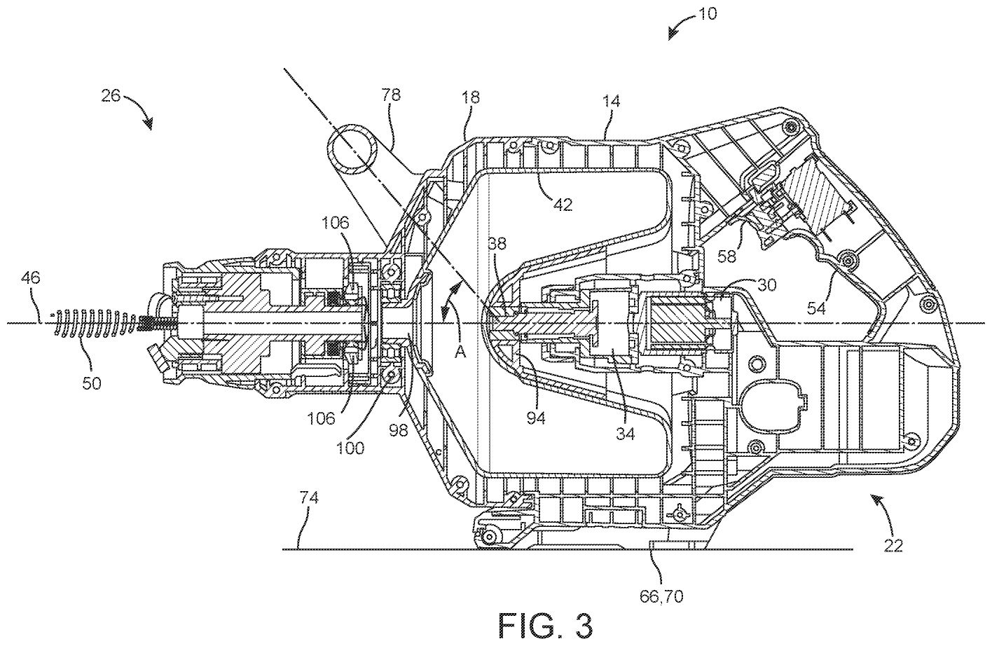

FIGS. 1-3 illustrate a drain cleaner 10. The illustrated drain cleaner 10 may include a housing 14, a cover 18 coupled to the housing 14, a handle assembly 22, and a nose assembly 26. As shown in FIG. 3, the drain cleaner 10 may also include a motor 30 and a drive mechanism 34 with an output shaft 38 positioned within the housing 14. The output shaft 38 may be coupled to a drum 42 to selectively rotate the drum 42 about a rotation axis 46 that extends through the output shaft 38 and the center of the nose assembly 26. The drain cleaner 10 may further include a flexible cable 50 that is stored within the drum 42 and extends out of the nose assembly 26. The cable 50 may be insertable into a drain, or other conduit, for cleaning the drain. In some embodiments, the cable 50 may include an auger head or other tool attachment at its distal end.

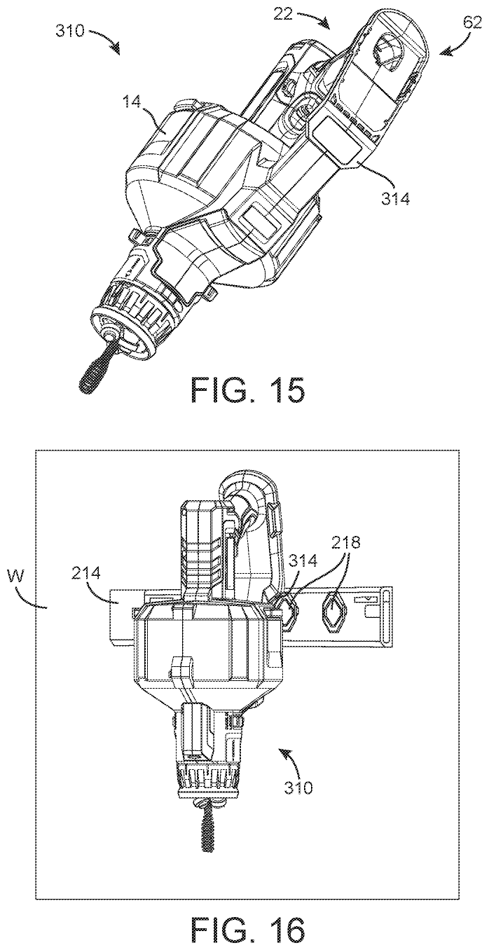

The handle assembly 22 may extend rearwardly from the housing 14. The handle assembly 22 may include a grip 54 that is configured to be grasped by a user for carrying and operating the drain cleaner 10. The handle assembly 22 may support an actuator 58 (e.g., a trigger) adjacent the grip 54. The actuator 58 may be actuatable (e.g., depressible) by a user to selectively energize the motor 30 and, thereby, operate the drain cleaner 10. The illustrated handle assembly 22 may also include a battery receptacle 62 (FIG. 1) for receiving and supporting a battery pack, such as a power tool battery pack. The battery receptacle 62 may include terminals that electrically connect the battery pack to the motor 30 and the actuator 58. In other embodiments, the handle assembly 22 may support or connect to a power cord to electrically connect the motor 30 to an AC power source. In the illustrated embodiment, the battery receptacle 62 may be on a side of the handle assembly 22 so that the battery pack is received in the battery receptacle 62 in a direction orthogonal to the rotation axis 46. In other embodiments, the battery receptacle 62 may be positioned elsewhere on the handle assembly 22 or drain cleaner 10. For example, the battery receptacle 62 may be positioned on a bottom side of the handle assembly 22 as shown in FIG. 15.

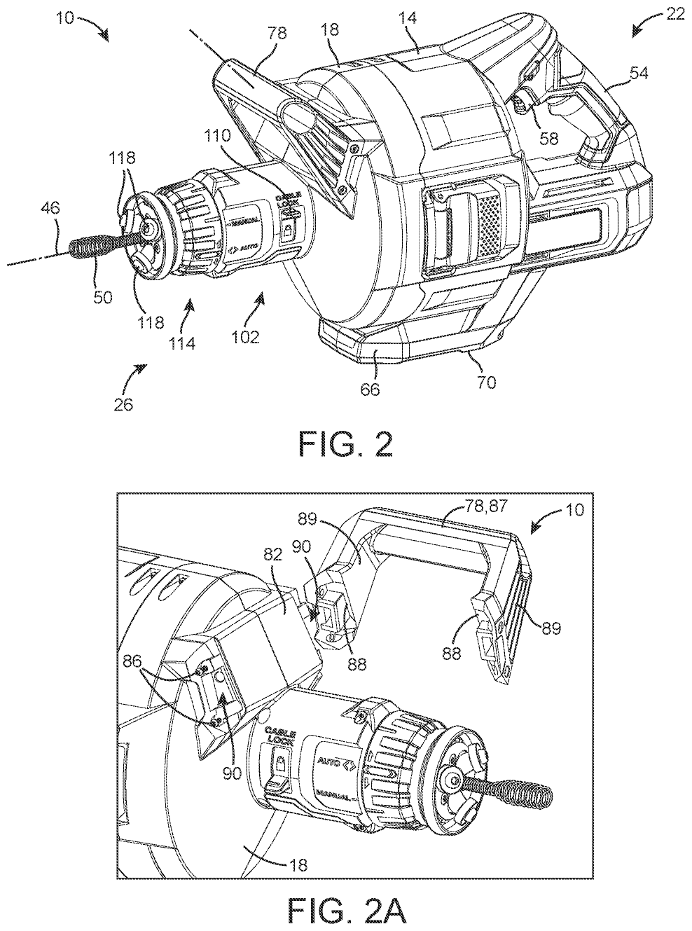

As shown in FIGS. 1 and 2, the illustrated handle assembly 22 may further include a stand 66. In one embodiment, the stand 66 may be a base. The stand 66 may be positioned generally beneath the housing 14 and the motor 30. More particularly, the stand 66 may be positioned beneath a center of gravity of the drain cleaner 10, which is principally defined by the motor 30, the drive mechanism 34, the cable 50, and the battery pack (if present) of the drain cleaner 10. The stand 66 may include a bottom surface 70 that is configured to engage and rest on a support surface 74 (e.g., a table, a workbench, a countertop, the floor, etc.). In one embodiment, the stand 66 may provide case of use during operation. The stand 66 may support the drain cleaner 10 in an upright position (as illustrated in FIG. 3) with the nose assembly 26 spaced apart from the support surface 74. In some embodiments, such as the illustrated embodiment, a bottom surface of the stand 66 may define a plane that is parallel to the rotation axis 46.

With reference to FIG. 2A, the cover 18 may include an auxiliary handle 78 extending away from the cover 18. The auxiliary handle 78 may be a removable auxiliary handle. The auxiliary handle 78 may be coupled to a top portion 82 of the cover 18 using fasteners 86 (e.g., screws, bolts, etc.). Specifically, the auxiliary handle 78 may be coupled to the cover 18 using four fasteners 86 (i.e., two on each side of the auxiliary handle 78). The auxiliary handle 78 may define a grip 87 and may include two flanges 89 extending from the ends of the grip 87. The grip 87 may be a hollow cylindrical tube that a user can grasp. The grip 87 may have a length that extends perpendicular to the rotation axis 46. The flanges 89 may couple to opposing sides (i.e., a first side and a second side) of the cover 18. Each flange 89 of the auxiliary handle 78 may include a rib 88 with a geometric shape that corresponds to a recess 90 on the top portion 82 of the cover 18. The rib 88 and the recess 90 may strengthen the connection between the auxiliary handle 78 and the cover 18 and allow for better support during operation by a user. The fasteners 86 may be removed with a tool (e.g., screwdriver) to remove the auxiliary handle 78. In other embodiments, the fasteners 86 may be snaps, magnets, or other suitable fasteners that can be disconnected without a tool (e.g., may instead be disconnected by applying a suitable force). When the auxiliary handle 78 is coupled to the top portion 82 of the cover 18, an opening 92 (FIG. 1) may be defined between the auxiliary handle 78 and the top portion 82 of the cover 18 through which a user can insert their hand and grasp the auxiliary handle 78. The auxiliary handle 78 may extend away from the cover 18 at an angle A (FIG. 3) relative to the rotation axis 46. The angle A may be an oblique angle. In the illustrated embodiment, the angle A may be between 30 degrees and 60 degrees. In other embodiments, the angle A may be less than 30 degrees or more than 60 degrees. During operation, a user may place one hand on the grip 54 and the other on the auxiliary handle 78 to support and stabilize the drain cleaner 10 during transport or operation.

With reference to FIG. 3, the drum 42 may be supported within the housing 14 by an inner cone 94. The inner cone 94 may be coupled to the drive mechanism 34 such that rotation of the motor 30 is transmitted to the drum 42 through the drive mechanism 34 and inner cone 94. Friction between the inner surface of the drum 42 and the cable 50 may cause the cable 50 to rotate or spin with the drum 42. As the drum 42 rotates, the cable 50 may also rotate. In some embodiments, the drain cleaner 10 may include a feed mechanism, described below, that engages the cable 50 as it rotates, causing the cable 50 to be extended into the drain or retracted from the drain. The illustrated drive mechanism 34 may include a gear train having, for example, planetary gear arrangements and the output shaft 38 that transmit rotation of the motor 30 to the drum 42. In some embodiments, the inner cone 94 and the drum 42 are integrally coupled together so that the drum 42 and the inner cone 96 are removed together from the interior of the housing 14. In some embodiments, the drum 42 may be threadably coupled to the inner cone 94. In other embodiments, the drum 42 may be coupled directly to the drive mechanism 34 using other suitable means to transmit force (e.g., rotation) from the drive mechanism 34 to the drum 42. Additionally, in some embodiments, other suitable drive mechanisms may also or alternatively be employed. As will be discussed in more detail below, the drum 42 may be removed from within the housing 14 and replaced with another drum.

The illustrated drum 42 may include a front portion or a nose piece 98 that extends away from the drum 42 and into the nose assembly 26. The nose piece 98 may guide the cable 50 from the drum 42 into the nose assembly 26. The nose piece 98 of the drum 42 may be positioned within a bearing 100 when the cover 18 is in a closed position. The bearing 100 may allow the drum 42 to rotate relative to the nose assembly 26 during operation. The nose assembly 26 may be positioned forward of the housing 14 and may provide an additional grip for a user to hold the drain cleaner 10 during operation. For example, a user can grasp the grip 54 of the handle assembly 22 with one hand to operate the actuator 58, and can grasp the nose assembly 26 with the other hand to help guide the drain cleaner 10. In contrast to the auxiliary handle 78, the grip of the nose assembly 26 may have a length that is parallel to, or even coaxial with, the rotation axis 46. As such, the grip 87 of the auxiliary handle 78 may be perpendicular to the grip of the nose assembly 26.

As illustrated in FIGS. 1 and 2, the nose assembly 26 may also provide a lock mechanism 102 for the drain cleaner 10. In the illustrated embodiment, the lock mechanism 102 may include two spring clips 106 (FIG. 3) positioned within the nose assembly 26 on opposite sides of the nose piece 98 of the drum 42. The lock mechanism 102 may include two tabs 110 that extend from an interior of the nose assembly 26. The lock mechanism 102 may be rotatable about the rotation axis 46 from a locked position to an unlocked position. When the lock mechanism 102 is rotated to the locked position, a cam surface (not shown) may push the spring clips 106 inwardly to engage the cable 50. In this position, the cable 50 may be forced to rotate with the drum 42. When the lock mechanism 102 is in the unlocked position, the spring clips 106 may be biased apart from each other and disengage the cable 50 so that the cable 50 can be fed out of or into the drum 42. In some embodiments, the lock mechanism 102 may be biased away from the drum 42 (i.e., toward an unlocked position) by a spring or other biasing member. Although the illustrated lock mechanism 102 is rotated between locked and unlocked positions, in other embodiments, the lock mechanism 102 may slide axially between the locked and unlocked positions.

With continued reference to FIGS. 1 and 2, the drain cleaner 10 may further include a cable feed mechanism 114 that helps guide and drive the cable 50 out of the drum 42 and into a drain. The cable feed mechanism 114 may be supported on the front end of the nose assembly 26. The cable feed mechanism 114 may include a plurality of rollers 118 that are moveable to engage the cable 50. The cable feed mechanism 114 may be rotatable about the rotation axis 46 between a manual feed position and an auto-feed position. When the cable feed mechanism 114 is in the manual feed position, the rollers 118 do not engage the cable 50, allowing a user to manually pay out or push in the cable 50 from the drum 42. As the cable feed mechanism 114 is moved from the manual feed position to the auto-feed position, the rollers 118 may move radially inward to engage the cable 50. With the cable 50 engaged by the rollers 118, when a user pushes the trigger 58 and the drum 42 rotates, the rollers 118 may allow the cable 50 to be paid out automatically from the drum 42 and into a drain or conduit.

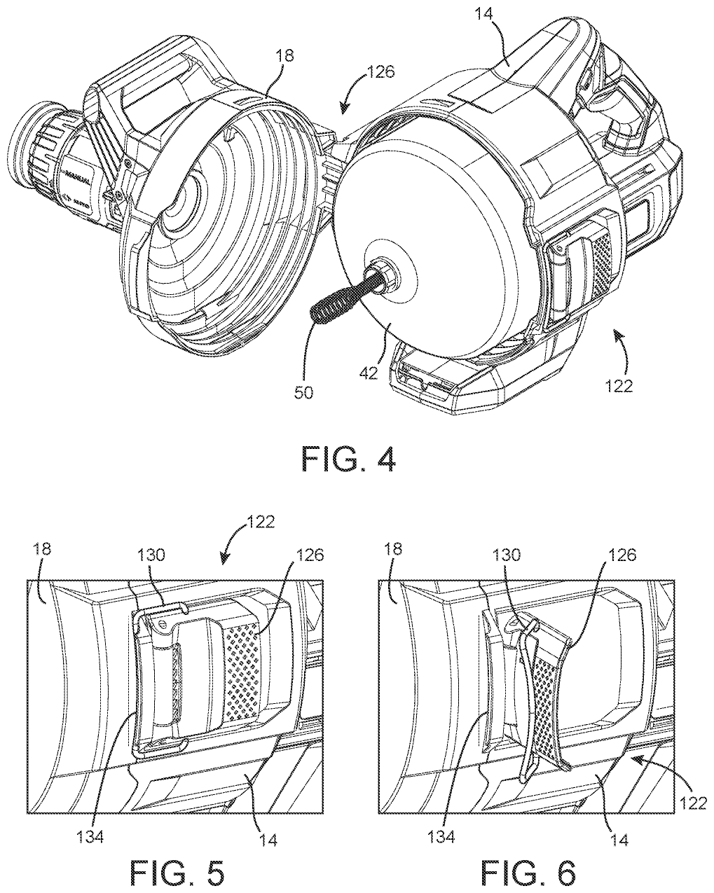

With reference to FIG. 4, the drum 42 may be removable from an interior of the housing 14. The cover 18 may be moveable from a closed position (FIG. 1) to an open position (FIG. 4) to allow access to the drum 42 and cable 50 within the housing 14. When in the closed position, the drum 42 may be completely enclosed by the housing 14 and the cover 18. As shown in FIGS. 5 and 6, a first latch mechanism 122 may be positioned on a first side of the housing 14. The first latch mechanism 122 may include an actuator 126 with a wire bar 130 coupled thereto. The actuator 126 may be pivotable from a first position (FIG. 5) to a second position (FIG. 6) to disengage the cover 18. Specifically, as the actuator 126 is pivoted, the wire bar 130 may move away from a clasp 134 on the cover 18 and the tension holding the cover 18 against the housing 14 may be removed. In other embodiments, the drain cleaner 10 may include other suitable latch mechanisms for the first latch mechanism 122.

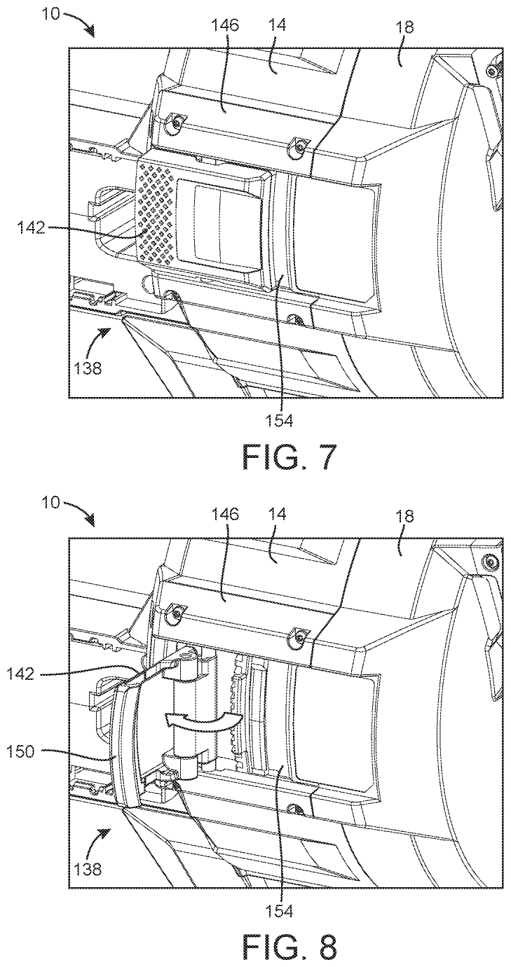

With reference to FIGS. 7 and 8, the drain cleaner 10 may also include a second latch mechanism 138 on an opposite side of the housing 14 from the first latch mechanism 122. The second latch mechanism 138 may also be referred to as a hinge. The second latch mechanism 138 may include an actuator 142 that is pivotable from a first position (FIG. 7) to a second position (FIG. 8) to release the cover 18 from the housing 14. The actuator 142 may be positioned within a support 146 of the housing 14 and may include a buckle 150 that corresponds to a rib 154 on the cover 18. The actuator 142 may be pivoted from the first position to the second position to release the cover 18 from the housing 14. In other embodiments, the drain cleaner 10 may include other suitable latch mechanisms for the second latch mechanism 138.

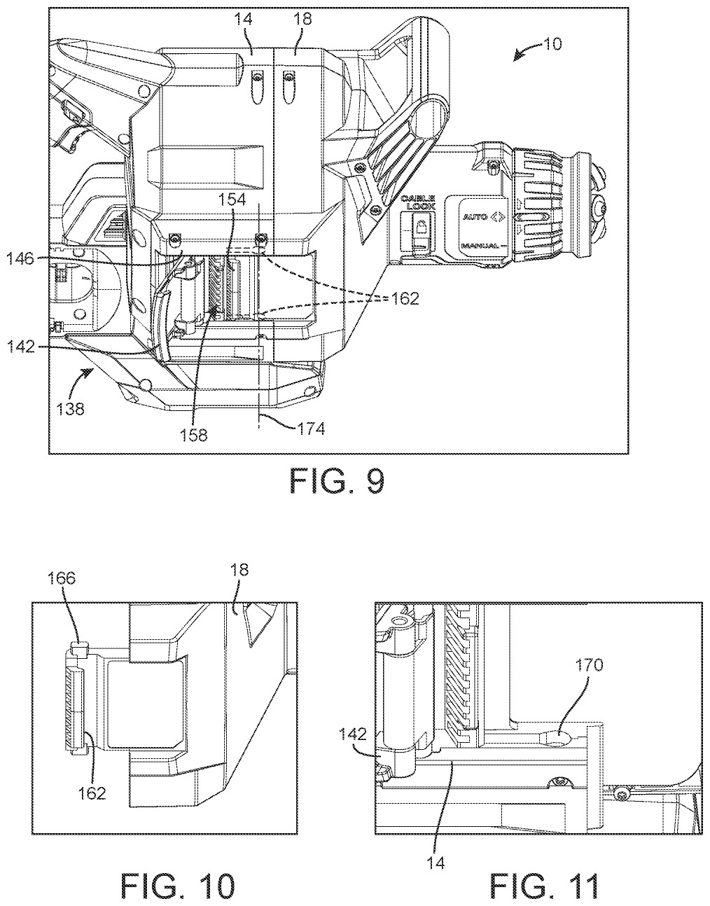

Moving to FIG. 9, the support 146 may define a channel 158 with a track 162 that the rib 154 of the cover 18 is moveable within. Once the second latch mechanism 138 is released, the cover 18 may slide forward to a pivoting position. Specifically, the rib 154 on the cover 18 may include two protrusions 166 (FIG. 10) on opposite sides that engage the track 162 (e.g., one protrusion 166 may be positioned within an upper portion of the track 162 and the other protrusion 166 may be positioned within a lower portion of the track 162). As the cover 18 is slid to the pivoting position, the protrusions 166 may slide along the track 162 until the protrusions 166 reach a bulb-shaped end 170 (FIG. 11) of the track 162. Once the protrusions 166 are within the bulb-shaped end 170, the cover 18 may be pivoted about an axis 174 defined by the protrusions 166 from the closed position to the open position to allow access to the drum 42 and cable 50. That is, the cover 18 may first slide linearly away from the housing 14, and then may pivot relative to the housing 14. In the illustrated embodiment, the axis 174 may be transverse to the rotation axis 46. More particularly, the axis 174 may be spaced apart from and perpendicular to the rotation axis 46.

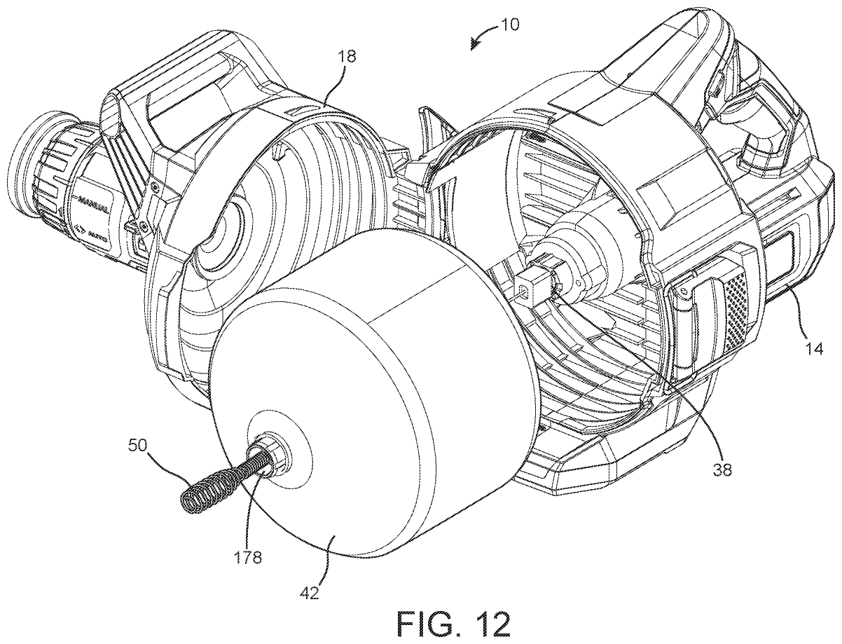

To remove the drum 42 from within the housing 14, a user may first release the first latch mechanism 122 by pivoting the actuator 126 from the first position to the second position, releasing the wire bar 130 from the clasp 134. Next, a user may release the second latch mechanism 138 by pivoting the actuator 142 from the first position to the second position, releasing the buckle 150 from the rib 154 of the cover 18. In other situations, the user may release the second latch mechanism 138 before the first latch mechanism 122, or may release both latch mechanisms 122, 138 simultaneously. Then, a user may slide the cover 18 away from the housing 14 until the cover 18 is in the pivoting position. As the cover 18 is pulled forward, the nose piece 98 of the drum 42 may be released from the cover 18. Specifically, sliding the cover 18 axially along the rotation axis 46 may allow the nose piece 98 to disengage the bearing 100 in the nose assembly 26 allowing the cover 18 to therefore pivot. Once in the pivoting position, a user may freely rotate the cover 18 about the axis 174 to gain access to the drum 42 and cable 50. As shown in FIG. 12, in the open position, a user may remove the cable 50 through a front opening 178 of the drum 42 or wind the cable 50 into the drum 42. Additionally, while in the open position, the user may completely remove the drum 42 from the housing 14 by gently pulling the drum 42 away from the housing 14. As the drum 42 is pulled away from the housing 14, the drum 42 and the inner cone 94 may be decoupled from the output shaft 38 of the drive mechanism 34. While removed, the drum 42 may be cleaned and returned to within the interior of the housing 14. Alternatively, once the drum 42 is removed, the drum 42 may be exchanged with a different drum. For example, the drum 42 may be exchanged with a newer drum and cable or for a drum with a different size/type of cable.

Providing a drain cleaner 10 with an auxiliary handle 78 allows a user to easily maneuver and use the drain cleaner 10 during operation. The drain cleaner 10 may include the grip 54, the auxiliary handle 78, and the nose assembly 26 that a user may choose to position their hands on when handling the drain cleaner 10. In addition, providing a drain cleaner 10 with a pivotable front cover 18 allows easier access to the drum 42 and cable 50 stored within the housing 14. It should be noted that providing the drain cleaner 10 with first and second latch mechanisms 122, 138 to move the cover 18 to an open position allows for easy access to the interior of the housing 14 without needing an additional tool or the need to remove fasteners.

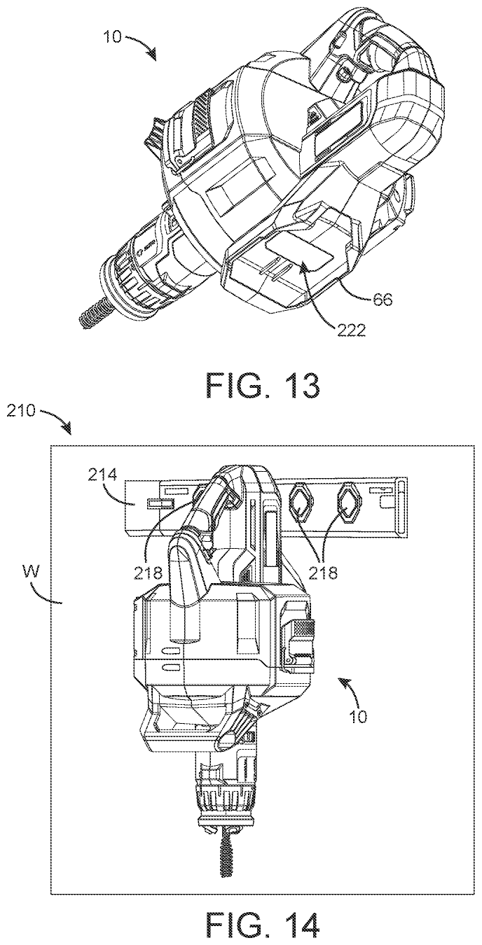

With reference to FIGS. 13 and 14, the drain cleaner 10 may be supported by an organization system 210. The organization system 210 may be a wall organization system, such as the one disclosed in U.S. application Ser. No. 17/396,282, filed Aug. 6, 2021, the entire contents of which are incorporated by reference herein. The organization system 210 may also be mounted to other suitable structures (e.g., cabinets, tables, etc.) or may be part of a storage box, tool box, or the like. The organization system 210 may include a mount or rail 214 having at least one cleat 218 that may be supported on a surface or a wall W. In the illustrated embodiment, the cleat 218 may be diamond-shaped. In other embodiments, the cleat 218 may have another shape (e.g., hexagonal, octagonal, etc.). As shown in FIG. 13, the stand 66 of the handle assembly 22 may include an opening 222 having a shape that corresponds to and receives the cleat 218. The engagement between the cleat 218 and the opening 222 of the drain cleaner 10 may be a locking engagement, or a gravitational engagement similar to a French cleat. As such, the drain cleaner 10 can be attached to the support surface (e.g., a wall W) through the rail 214. Further, the engagement between the cleat 218 and the opening 222 may be referred to an over-the-diamond interface since the opening 222 receives the cleat 218.

FIGS. 15 and 16 illustrate a drain cleaner 310 according to another embodiment. The drain cleaner 310 may be similar to the drain cleaner 10 described above with like features being represented with like reference numbers. The drain cleaner 310 may include the handle assembly 22, however, the handle assembly 22 may include a flange portion 314 connecting the battery receptacle 62 to the housing 14. The flange portion may include a reduced width compared to the rest of the handle assembly 22. As shown in FIG. 16, the flange portion may be configured to engage the space between two cleats 218 of the organization system 210. As such, the drain cleaner 310 can be attached to the support surface (e.g., a wall W) through the rail 214. The engagement between the flange portion 314 of the drain cleaner 310 and the cleats 218 may be referred to as a between-the-diamond interface.

Although the invention has been described in detail with reference to certain preferred embodiments, variations and modifications exist within the scope and spirit of one or more independent aspects of the invention as described. Various features and advantages of the invention are set forth in the following claims.

1. A drain cleaner comprising:
a housing having an interior;
a cover coupled to the housing over the interior;
a nose assembly extending forwardly from the cover to define a first grip;
a handle assembly extending rearwardly from the housing and including a second grip;
a motor positioned within the housing, the motor defining a rotation axis;
a drum positioned within the interior, the drum operable to be rotated by the motor relative to the housing;
a flexible cable stored within the drum, the flexible cable configured to be extended out of the drum and into a drain; and
an auxiliary handle extending from the cover and including a third grip, the auxiliary handle defining an opening between the third grip and the cover.

2. The drain cleaner of claim 1, wherein the auxiliary handle is removably coupled to the cover.

3. The drain cleaner of claim 1, wherein the auxiliary handle extends away from the cover at an angle between 30 degrees and 60 degrees relative to the rotation axis.

4. The drain cleaner of claim 1, wherein the handle assembly includes a stand positioned beneath a center of gravity of the drain cleaner.

5. The drain cleaner of claim 1, wherein the handle assembly includes a battery receptacle configured to receive a battery pack.

6. The drain cleaner of claim 1, wherein the third grip has a length that extends perpendicular to the rotation axis.

7. The drain cleaner of claim 1, wherein the auxiliary handle includes two flanges extending from ends of the third grip and coupled to opposing sides of the cover.

8. The drain cleaner of claim 1, wherein the auxiliary handle includes a cylindrical tube.

9. The drain cleaner of claim 1, wherein the cover is pivotably coupled to the housing and moveable between a closed position, in which the drum is enclosed within the interior, and an open position, in which the drum is accessible.

10. A drain cleaner comprising:
a housing having an interior;
a motor positioned within the housing, the motor defining a rotation axis;
a drum positioned within the housing, the drum operable to be rotated by the motor relative to the housing;
a flexible cable stored within the drum, the flexible cable configured to be extended out of the drum and into a drain; and
a cover pivotably coupled to the housing, the cover pivotable between a closed position, in which the drum is enclosed within the interior, and an open position, in which the drum is accessible.

11. The drain cleaner of claim 10, wherein when the cover is in the open position, the drum is removable from the interior of the housing.

12. The drain cleaner of claim 10, wherein the drum is supported by an inner cone within the interior of the housing.

13. The drain cleaner of claim 10, further comprising a first latch mechanism coupled to the housing and the cover, wherein the first latch mechanism is moveable from a first position, in which the cover is secured to the housing, and a second position, in which the cover is able to move between the open and closed positions.

14. The drain cleaner of claim 13, further comprising a second latch mechanism coupled to the housing and the cover, wherein the second latch mechanism is moveable between a first position, in which, the cover is not pivotable relative to the housing, and a second position, in which the cover is pivotable between the open and closed positions.

15. The drain cleaner of claim 14, wherein the first and second latch mechanisms are positioned on opposite sides of the housing from one another.

16. The drain cleaner of claim 10, wherein the cover is pivotable about an axis that is transverse to the rotation axis.

17. A system comprising:
an organization system including a cleat; and
a drain cleaner including,
a housing,
a motor positioned within the housing,
a handle assembly extending from the housing, the handle assembly including a stand with an opening, the opening configured to receive the cleat to connect the drain cleaner to the organization system,
a drum positioned within the housing, the drum operable to be rotated by the motor relative to the housing, and
a flexible cable stored within the drum, the flexible cable configured to be extended out of the drum and into a drain.

18. The system of claim 17, wherein the cleat is diamond shaped.

19. The system of claim 17, wherein the organization system includes a rail configured to be mounted to a wall, and wherein the cleat extends from the rail.

20. The system of claim 17, wherein the cleat is a first cleat, and wherein the organization system further includes a second cleat.
